(19) United States
(12) Patent Application Publication
(10) Pub. No.: US 2017/0159353 A1
(43) Pub. Date: Jun. 8, 2017

(54) Size-Adjustable Pet Door

(71) Applicant: Radio Systems Corporation, Knoxville, TN (US)

(72) Inventor: Kenneth Clifton, Knoxville, TN (US)

(21) Appl. No.: 14/959,215

(22) Filed: Dec. 4, 2015

(51) Int. Cl. E06B 7/32; E06B 1/02; E06B 3/70; E06B 1/04; E05C 19/16

(52) U.S. Cl. CPC E06B 7/32; E06B 1/04; E05C 19/16; E06B 3/70; E06B 1/02; E06B 2003/7053; E06B 2003/7059; E06B 2003/7096; E06B 2003/7057

(57) ABSTRACT

A size-adjustable animal door is provided. The door includes a pair of opposing frame units configured to be secured to opposing sides of a door or other barrier. Each frame unit comprises slidably mating components that permit each frame unit to have (i) an adjustable height, (ii) an adjustable width, or (iii) both The slidably mating components of each frame unit form an opening configured to align with a pre-cut opening in a door, forming a passageway for an animal. The door also includes a flap unit fabricated from a flexible material having a series of cutting guides to facilitate the custom fitting of the flap unit in the door opening. The door also includes a pivoting connection member arranged to connect the flap unit to a horizontal, upper frame member along the first frame unit. The door may also include a panel unit that is gravitationally received in u-channels along one of the frame units to block the flap unit. A method of installing a pet door is also provided.

### CROSS REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present inventive concept relates to the field of pet doors. More particularly, the invention relates to a “one size fits all” pet door system, wherein the size of a pet door may be adjusted after purchase to meet the needs of an owner's pet as the pet grows.

### TECHNOLOGY IN THE FIELD OF THE INVENTION

Conventional pet doors are typically installed at a structure, such as a residential door or wall, to enable a domestic pet to traverse through the structure by way of the pet door. These pet doors typically include a frame and flap, or a frame and a pocket door. The frame defines a passageway sufficient for a pet to pass through and is typically installed by first cutting a through-opening in the structure. The frame cooperates with the structure at the through-opening such that, when the frame is installed, the passageway is defined at the through-opening to the extent that the passageway provides a passage through the structure.

The flap is disposed proximate the passageway and is movable between a closed position and an open position. When at the closed position, the flap substantially covers the passageway such that environmental elements do not pass there through. When at the open position, the flap permits the pet to pass through the passageway. The flexible flap member allows the pet to freely pass in and out as needed or desired.

In known pet doors, the through-opening is often cut according to the location of a pre-existing panel. Where no pre-existing panel exists, the owner may cut the through-opening at a location such that when the conventional pet door is installed, the height of the passageway is appropriate for the specific pet using the pet door. For example, the pet door may be installed at a height that permits the pet to access the pet door without having to jump or to uncomfortably crouch.

Patents for pet doors have been issued since at least the 1950's. U.S. Pat. No. 2,748,854, entitled “Dog Door” and issued in 1950, discloses a door frame having upper and lower frame members and opposing side members. The frame supports a pair of “flexible and resilient sheets which overlap along the center line of the frame.” The frame members are connected at their corners by mitered joint members having mounting flanges secured by the use of bolts. Of interest, the location of the flaps can be moved during installation so that the amount of overlap can be adjusted as desired, but the frames themselves are of fixed dimensions.

Conventional pet doors are limited in that the height of the passageway is not adjustable to account for a growing pet or for a subsequent pet. For example, when a conventional pet door is installed to be used by a puppy, the height of the passageway becomes inappropriately low as the dog matures and increases in size. As another example, when a conventional pet door is installed to be used by a taller pet, the height of the passageway becomes inappropriately high when a subsequent shorter pet is acquired.

In circumstances such as these, a conventional pet door must be uninstalled and the through-opening must be modified such that the pet door can be reinstalled at the more appropriate height. More specifically, to adjust the height of a conventional pet door, additional cuts must be made in the structure to provide a though-opening at an appropriate height or location for proper installation of the pet door. This means that an entirely new pet door system must be purchased.

U.S. Pat. No. 8,434,264, entitled “Animal Door Having An Adjustable Height,” offered a pet door that provides a passageway having an adjustable height. More specifically, the animal door is capable of being installed at the structure at one of two orientations, whereby the orientation at which the animal door is installed governs the height of the door. Additionally, the animal door is removably installed at the structure such that the orientation, and thus the height, of the door is reversible.

While the '264 patent presents a clever way for providing a height-adjustable pet door, it is observed that the owner must still remove the frame, rotate the frame by 90°, and then reinstall the frame. A “flap unit” secured within the perimeters of the frame is also provided. The flap unit includes a flap, and opposing flap receptors. When the frame is rotated, the flap must be re-secured.

It is further observed that while the '264 patent enables an owner to adjust the relative location of the through-way within an animal door, the door frame itself has a fixed size. Thus, if the pet owner desires an animal door having larger or smaller overall dimensions for either the frame or the flap, then a different sized product must be purchased. The result is that a store seeking to offer an animal door of different sizes must still stock multiple-sized animal door products.

A need exists for an improved animal door wherein the size of the frame for the animal door may be adjusted by the pet owner after purchase to accommodate the changing size of a through-opening placed through a door. Further, a need exists for a “one size fits all” animal door, wherein a retailer need not stock multiple animal doors having different frame sizes, but need only stock replacement flap units.

### BRIEF SUMMARY OF THE INVENTION

A size-adjustable pet door is first provided herein. In one embodiment, the pet door comprises a first frame unit and a second opposing frame unit. The two frame units are designed to be placed on opposing surfaces of a structural barrier such as a wall or a door. The frame units are preferably configured to be secured to the wall or door by means of a mechanical fastener such as a bolt.

Each frame unit is configured to form a four-sided polygon, meaning a rectangle or a square. In one embodiment, each frame unit comprises four floating corner pieces, with each corner piece forming a right angle. In addition, each frame unit comprises at least one pair of opposing bars. The bars are configured to slidably mate with right angle ends of corresponding corner pieces. In one aspect, the sliding bars have extensions (or tenons) that are configured to slide into openings (or mortises) at the right angle end of a corresponding corner piece. Alternatively, the sliding bars have openings (or mortises) that are configured to receive extensions (or tenons) at the right angle end of a corresponding corner piece.

Preferably, each frame unit comprises two pairs of opposing, slidable bars, permitting the pet owner to adjust both the height and the width of the frame units. The four floating corner pieces and the slidably mating bars together form an opening for the two frame units. The opening aligns with a pre-cut through-opening in a structural barrier, forming a passageway for an animal.

The pet door also has a flap unit. In one embodiment, the flap unit is pivotally secured to a horizontally-oriented bar placed at the top of one of the frame units. In another embodiment, a door panel drops down into channels placed along an external face of one of the frame units. The door panel may be used in addition to or instead of the pivoting flap unit. In either arrangement, the flap unit is fabricated from a polymeric (or other flexible) material that may be cut-to-size by the pet owner. Corrugations are optionally provided along opposing left and right panels to facilitate flexing and/or cutting. In one aspect, the flap unit also includes a bottom panel having a corrugated profile. Creases in the corrugated profiles provide ready cutting guides for the pet owner, allowing the pet owner to adjust the height and/or width of the flap unit to match the size of the opening.

A method for installing a pet door is also provided herein. In one aspect, the method includes cutting a through-opening through a barrier, such as a wall or a door. The through-opening is preferably sized to accommodate a pet dog of a particular size. Thus, the method may also include the step of determining a first size of a pet, wherein the through-opening accommodates the first size of the pet.

The method next includes providing a size-adjustable pet door. The pet door may be in accordance with the pet door as described above in its various embodiments. The pet door will have a first frame unit and a second frame unit, with each frame unit forming a four-sided polygon. Each frame unit comprises slidably mating components that permit each frame unit to have (i) an adjustable height, (ii) an adjustable length, or (iii) both. The pet door will also have a first flap unit fabricated from a polymeric (or other flexible) material.

The method further includes connecting the slidable components of each frame unit to form a first opening. The first opening generally aligns with the through-opening of the door.

The method also includes cutting the first flap unit along the cutting guides to match the first opening, and then connecting the first flap unit to the first frame unit. Preferably, the connection is across an upper horizontal bar of the first frame unit. Because of the flexible or compliant nature of the flap unit, the connection becomes a pivoting connection even though the hardware associated with the frame unit is fixed. Alternatively, connecting the first flap unit to the first frame unit may comprise gravitationally releasing the first flap unit into two or more u-shaped channels disposed along an outer surface of the first frame unit.

The method additionally includes placing the first frame unit along a first surface of the door (or other barrier), and placing the second frame unit along a second opposing surface of the door (or other barrier). Using a mechanical fastener, the first frame unit is secured to the second frame unit in fixed relation to the door. In this way, a passageway for an animal is formed.

In one embodiment, the method further comprises:
determining a second size of the pet after a period of time;
removing the first flap unit from the first frame unit;
removing the first and second frame units from the door;
cutting the door to expand the through-opening in the door and to accommodate the second size of the pet;
connecting the slidable components of each frame unit to form a second opening within the frame units that aligns with the expanded through-opening of the door;
providing a second flap unit to replace the first flap unit, the second flap unit also having cutting guides;
cutting the second flap unit along the cutting guides to match the opening in the frame units, wherein the second flap unit has a larger dimension than the first flap unit;
connecting the second flap unit to the first frame unit;
placing the first frame unit back along the first surface of the door, and placing the second frame unit back along the second opposing surface of the door; and
using a mechanical fastener, re-securing the first frame unit to the second frame unit in fixed relation to the door, thereby re-forming the passageway for the pet.

In this way, the same frame units may be used as a pet grows. Of course, these additional steps can be repeated to expand the through-opening to accommodate a third determined size of the pet, or to accommodate a separate larger pet. The only change in hardware that is needed with each increased size adjustment is a new flap unit, ready to be cut to size.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of an animal door of the present invention, in one embodiment. The view shows first and second frame units, and an intermediate flap unit. The frame units and flap unit are shown in exploded-apart relation.

FIG. 2 is another perspective view of the animal door of FIG. 1. Here, the two frame units are affixed to opposing surfaces of a door. The frame units form an opening that aligns with a through-opening formed in the door.

FIG. 3A is a front view of a frame unit having a first dimension. The frame unit secures a flap unit within the opening.

FIG. 3B is another front view of the frame unit of FIG. 3A having a second larger dimension. Here, the slidable components of the frame unit have been adjusted to accommodate a taller and wider through-opening in the door.

FIG. 3C is another front view of the frame unit of FIG. 3A having a third dimension. Here, the slidable components of the frame unit have been adjusted to accommodate a wider through-opening in the door.

FIG. 3D is another front view of the frame unit of FIG. 3A having a fourth dimension. Here, the slidable components of the frame unit have been adjusted to accommodate a taller through-opening in the door.

FIG. 4A is an enlarged perspective view of the flap unit of FIG. 1. Left and right side panels, and a bottom panel, are more clearly seen.

FIG. 4B is a further enlarged perspective view of the flap unit of FIG. 4A. Here, a corrugated profile of the left panel is more clearly seen.

FIG. 5A is an enlarged perspective view of the flap unit of FIG. 1. The bottom panel is more clearly seen.

FIG. 5B is a further enlarged perspective view of the flap unit of FIG. 5A. Here, the corrugated, or ridged, profile of the bottom panel is more clearly seen.

FIG. 6 is a perspective view of an animal door of the present invention, in a second embodiment. The view shows first and second frame units shown in exploded-apart relation.

FIG. 7 is another perspective view of the animal door of FIG. 6. Here, the two frame units are affixed to opposing surfaces of a wall. The frame units form an opening that aligns with a through-opening formed in the wall.

FIG. 8A is a front view of a frame unit having a first dimension. The frame unit has received a slidable panel unit within u-shaped channels.

FIG. 8B is another front view of the frame unit of FIG. 8A having a second larger dimension. Here, the slidable components of the frame unit have been adjusted to accommodate a taller and wider through-opening in a wall.

FIG. 8C is another front view of the frame unit of FIG. 8A having a third dimension. Here, the slidable components of the frame unit have been adjusted to accommodate a wider through-opening in the wall.

FIG. 8D is another front view of the frame unit of FIG. 8A having a fourth dimension. Here, the slidable components of the frame unit have been adjusted to provide a taller through-opening in the wall.

FIG. 9A is a perspective view of a slidable flap unit, in one embodiment. Here, an upper handle is shown residing horizontally over the panel unit.

FIG. 9B is an enlarged view of the slidable panel of FIG. 9A. Vertical corrugations and an optional pre-marked, horizontal cutting line are seen.

FIG. 10 is an enlarged perspective view of a portion of one of the frame units from FIG. 6. A portion of a vertical channel and a portion of a horizontal channel are seen, configured to gravitationally receive the slidable panel unit of FIG. 8A.

### DETAILED DESCRIPTION OF CERTAIN EMBODIMENTS

### Definitions

As used herein, the term “corrugated” refers to any sinusoidal contour, or a ridges-and-trough contour.

As used herein, the term “crease” refers to any linearly indented feature or trough along a profile. The crease may or may not be perforated.

As used herein, the term “slidably mating” includes any telescoping configuration, or mortise-and-tenon configuration wherein one member receives at least a portion of another member.

As used herein, the term “pivoting” includes the use of a flexible or compliant member attached to a fixed member using fixed hardware.

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### DESCRIPTION OF SELECTED SPECIFIC EMBODIMENTS

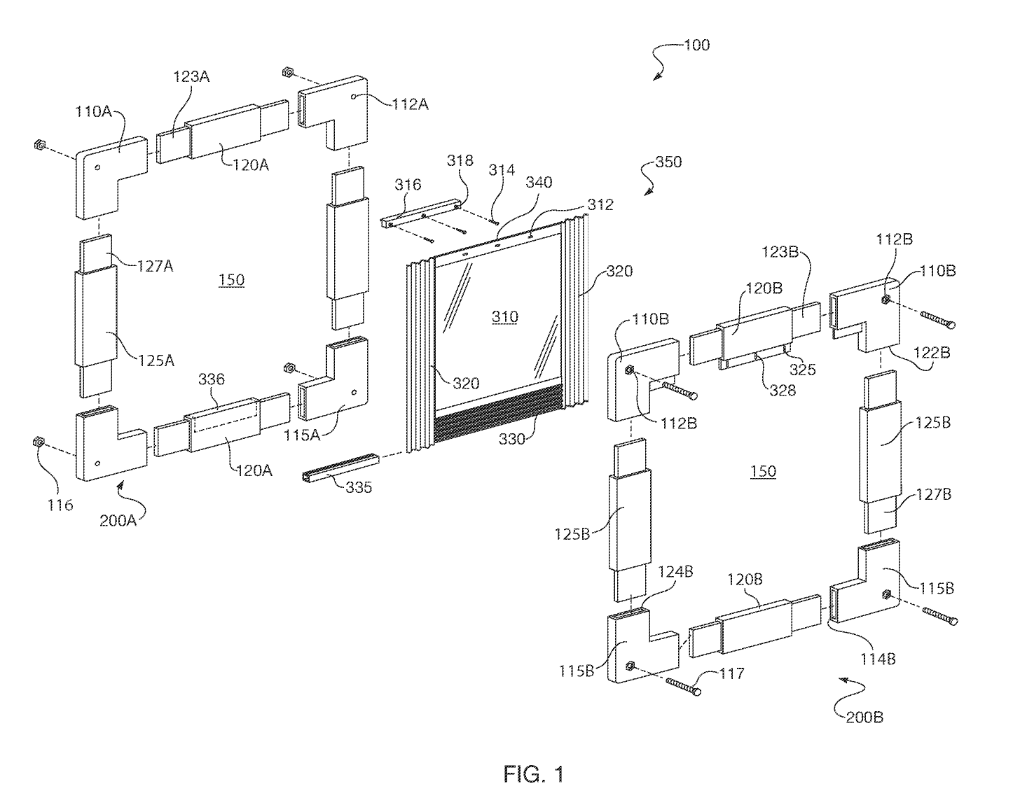

FIG. 1 is a perspective view of an animal door 100 of the present invention, in one embodiment. The view shows first 200B and second 200A frame units, and an intermediate flap unit 350. The frame units 200B, 200A and flap unit 350 are shown in exploded-apart relation.

Referring specifically to the first frame unit 200B, the first frame unit 200B comprises four separate floating corner pieces. The corner pieces include two upper floating corner pieces 110B and two lower floating corner pieces 115B. Each corner piece 110B, 115B defines a body forming a right angle, with each body having opposing right angle ends.

The first frame unit 200B also includes four bars. The bars include left and right opposing side bars 125B, and top and bottom bars 120B. The left and right side bars 125B are of the same length, and the top and bottom bars 120B are of the same length. In one aspect, the left and right side bars 125B and the top and bottom bars 120B are all of the same length. The top bar includes a flap mounting flange 325 having flap mounting holes 328 there through.

The left, right, top and bottom bars 125B and 120B, respectively, connect to corresponding generally right angle ends of the corner pieces 110B, 115B through slidable or telescopic connections, shown in the drawings as mortise-and-tendon type connections, to form right and left length adjustable bar members, and top and bottom length adjustable bar members. In the illustrative arrangement of FIG. 1, the tenons reside at opposing ends of the left and right side bars 125B, while the mortise openings reside within the right angle ends of the corner pieces 110B and 115B. The tenon portions of the left and right side bars 125B are shown at 127B, while the tenon portions of the top and bottom bars 120B are shown at 123B. The mortise openings are indicated at 114B and 124B.

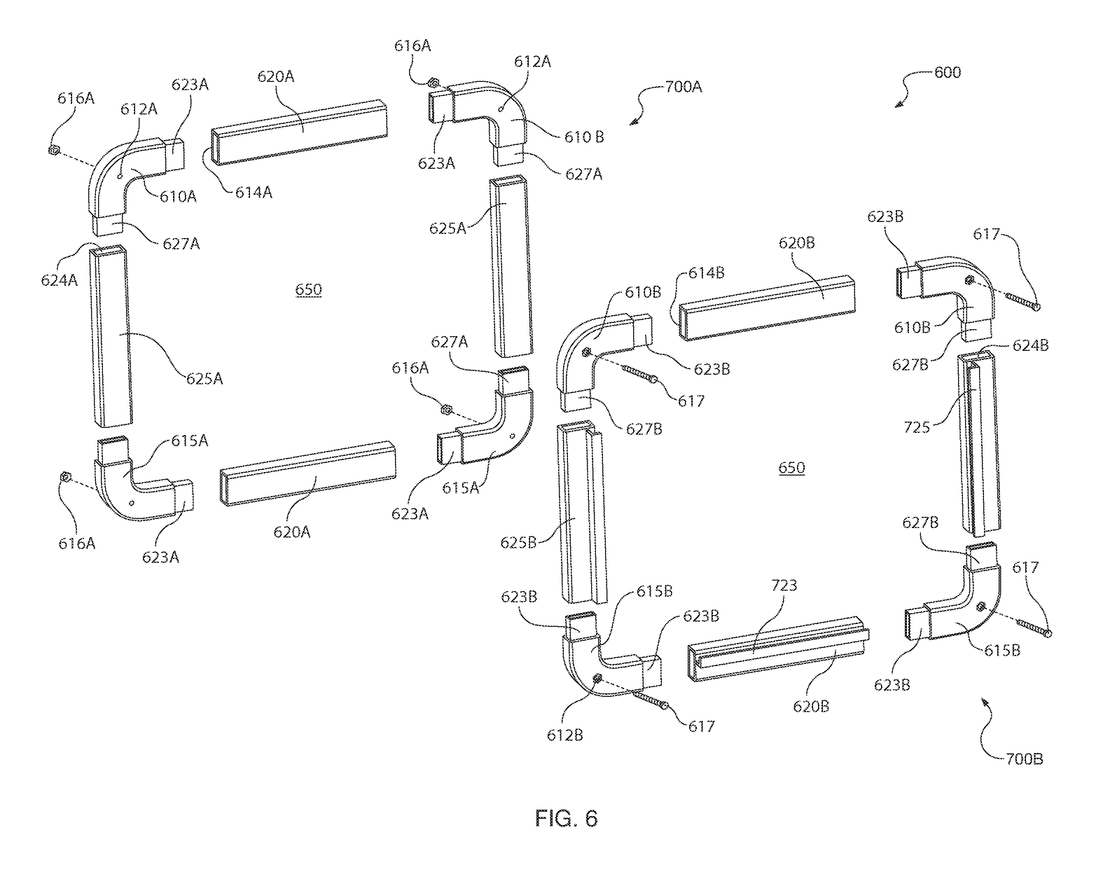

It is understood that the mortise-and-tenon arrangement may be reversed. In this respect, the tenons may reside at the right angle ends of the corner pieces 110B, 115B, while the mortise openings may reside at opposing ends of the side bars 120B and 125B. This is demonstrated in connection with animal door 600, shown in FIG. 6 and discussed further below. In either aspect, the first frame unit 200B forms a collection of slidable or telescopic components. Sliding the components allows a pet owner, or pet door installer, to readily adjust a size of an opening 150 formed by the components of the frame unit 200B through relative positioning of the side bars 120B and 125B into the corner pieces 110B and 115B.

It is observed here that the second frame unit 200A is formed generally of the same slidable or telescopic components. Thus, floating corner pieces 110A, 115A correspond to floating corner pieces 110B, 115B; left and right side bars 125A correspond to left and right side bars 125B, and top and bottom bars 120A correspond to top and bottom bars 120B, thereby forming right and left bar members as well as top and bottom bar members.

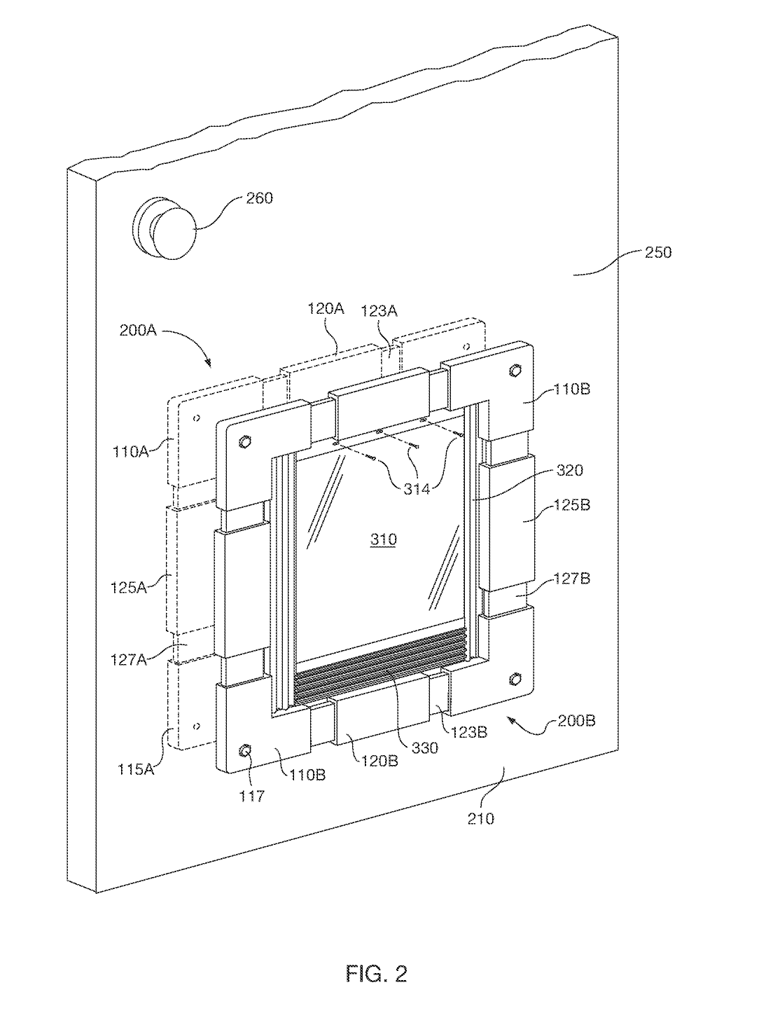

The first 200B and second 200A frame units are designed to be coupled to each other so as to be fixedly attached to a structure, such as a residential door or wall. FIG. 2 is another perspective view of the animal door 100 of FIG. 1. Here, the two frame units 200A, 200B are affixed to opposing surfaces of a residential door 250. The door 250 has a lower end adjacent a floor surface (not shown) and a door knob 260. The frame units 200A, 200B form an opening (shown covered by flap surface 310) that aligns with a through-opening (not visible) formed (typically by manually cutting) in the door 250.

In order to secure the first 200B and second 200A frame units to the residential door 250, one or more mechanical connectors 117 is provided, which are shown in the drawings in the form of bolts 117. In the arrangement of FIGS. 1 and 2, bolts 117 are placed through mounting holes 112B in the corner pieces 110B, 115B. The bolts 117 extend through holes in the door 250 and through corresponding mounting holes 112A in the corner pieces 110A, 115A. Nuts 116 are then threaded onto the bolts 117 and tightened to provide a fixed connection to the residential door 250 there between.

The animal door 100 also includes a flap unit 350 coupled to the first and second frame units 200B and 200A. The flap unit 350 is pivotally secured to the first frame unit 200B. Of course, it is understood that the flap unit 350 may alternatively be attached to the second frame unit 200A inasmuch as the first 200B and second 200A frame units are essentially interchangeable.

The flap unit 350 defines a flexible, planar surface fabricated from a pliable material such as polyethylene, natural rubber, polypropylene, iso-propylene or other elastomeric material.

The flap unit 350 includes a central panel 310 and two oppositely disposed side panels 320 extending laterally from the central panel 310. The central panel 310 has a top edge with three mounting holes 312 there through which are configured to align with flap mounting holes 328 within the flap mounting flange 325. (The flap mounting flange 325 extends down from upper bar 120B.) Each of the side panels 320 has a corrugated profile, forming a series of vertical creases 322. The corrugated profile of the side panels 320 allows the flap unit 350 to maintain an inherent spring property, biasing the central panel 310 outwardly when compressed.

The flap unit 350 further includes a bottom panel 330 extending downwardly from the central panel 310. The bottom panel 330 likewise includes a corrugated, or ridged, profile forming horizontal creases 332. Of interest, the left and right side panels 320 bound opposing ends of the bottom panel 330.

The creases in the left, right panels 320 and the bottom panel 330 form vertical and horizontal cutting guides, respectively, for the pet owner, or the pet door installer. In this way, the flap unit 350 may be cut to conform to the selected size of the opening 150 provided by the positioning of frame units 200B, 200A. It is understood that if the dimensions of the opening 150 are changed after installation, such as when a pet grows to a larger size or when a new pet is acquired, a new flap unit 350 will need to be cut and installed should the new opening 150 be longer and/or wider than the size of the original opening.

The flap unit 350 also includes a connection bar 316 having three mounting holes 318 therein. The mounting holes 318 are configured to align with central flap mounting holes 312. As such, mechanical fasteners, such as mounting bolts or screws 314 are passed through the flap mounting holes 328 of the flap mounting flange 325, through the mounting holes 312 of central panel 310, and threaded into mounting holes 318 of the central bar 316 to pivotally secure the flap unit 350 to the first frame unit 200B.

Lastly, the flap unit 350 includes a magnetic element 335 that engages the bottommost ridge of the bottom panel 330. The magnetic element 335 is magnetically drawn to a ferro-magnetic element 336 disposed in bottom bar 120B to bias the flap unit 350 to a flap closed position.

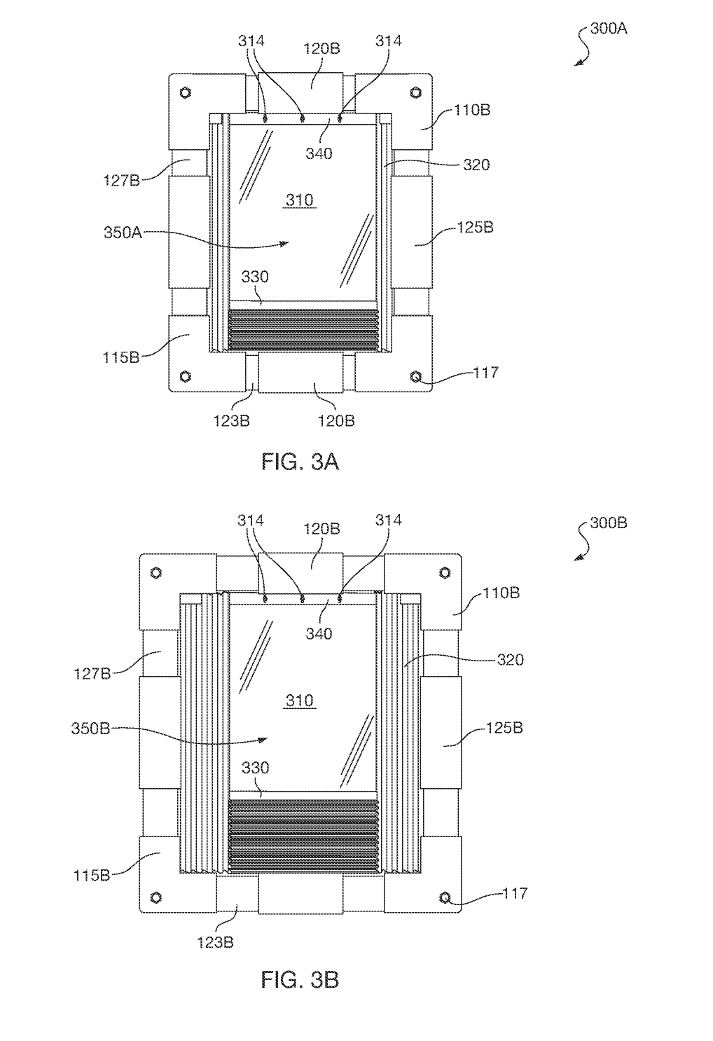

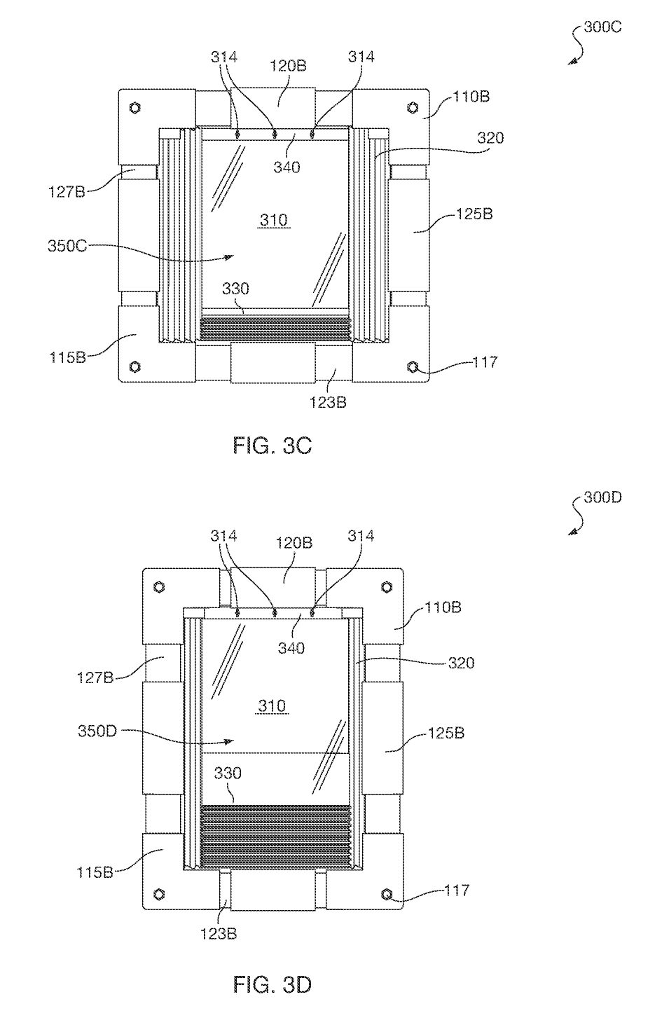

FIG. 3A is a front view of the animal door 100, presented as 300A, wherein the first frame unit 200B is shown having a very small or compact first dimension or configuration. The animal door 300A has the right and left side bars 125B pushed against corner pieces 110B and 115B to provide a minimal height, i.e., the tendons 127B of the corner pieces are pushed fully into mortise openings 124B of the corner pieces 110B and 115B. Similarly, the top and bottom bars 120B pushed against corner pieces 110B and 115B to provide a minimal width, i.e., the tendons 123B of the corner pieces are pushed fully into mortise openings 114B of the corner pieces 110B and 115B.

FIG. 3B is another front view of the animal door 100, presented as 300B. Here, slidable components of the frame unit 200B have been adjusted to accommodate a both taller and wider through-opening in the door 300B as compared to FIG. 3A. The animal door 100 has the right and left side bars 125B pushed distally from corner pieces 110B and 115B to provide a maximum height, i.e., the tenons 127B of the side bars 125B are positioned farthest from mortise openings 124B of the corner pieces 110B and 115B. Similarly, the top and bottom bars 120B are pushed distally from corner pieces 110B and 115B to provide a maximum width, i.e., the tenons 123B of the bars 120B are pushed farthest from mortise openings 114B of the corner pieces 110B and 115B.

FIG. 3C is another front view of the animal door 100, presented as 300C. Here, the animal door 300C is configured to be wider than that shown in FIG. 3A. This configuration allows a wider opening for the passage of shorter, squattier pets. This accommodates a pet that has grown wider over time, or perhaps accommodates two smaller pets at one time. Note that the bottom panel 330 and the bottoms of the side panels 320 of the flap unit 350 have been cut to match the size of the opening formed by the frame unit 200B.

FIG. 3D is another front view of the animal door 100, presented as 300E. Here, the slidable components of the frame unit 200B have been adjusted to accommodate a taller through-opening in the door 250 as compared to FIG. 3A. This accommodates a pet that has grown taller over time. Note that the sides of the side panels 320 of the flap unit 350 have been cut to match the narrower size of the opening formed by the frame unit 200B.

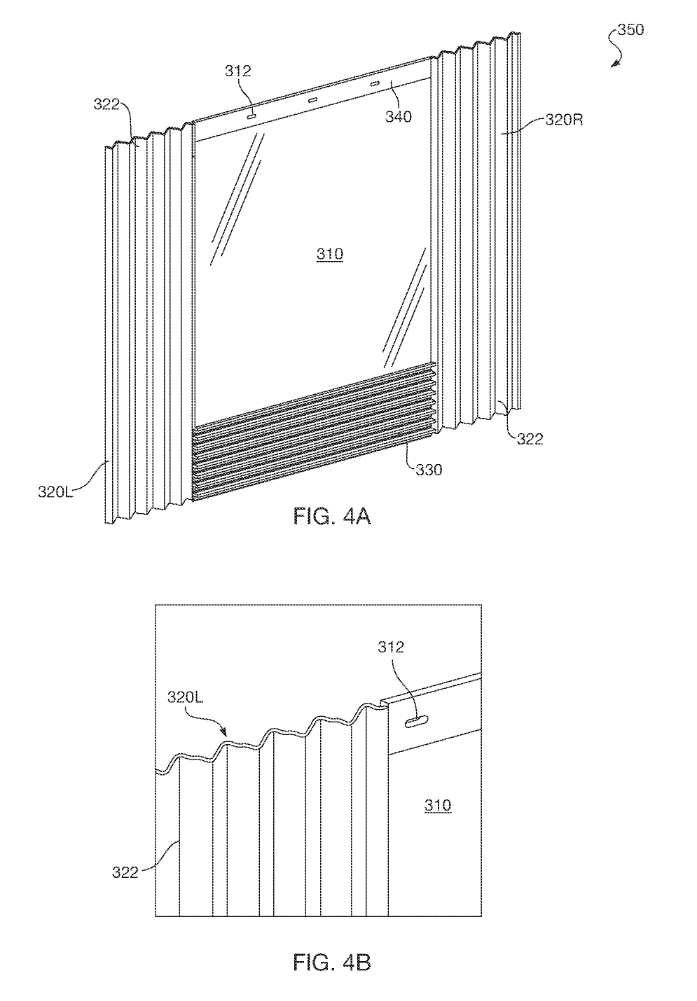

FIG. 4A is an enlarged perspective view of the flap unit 350 of FIG. 1. Left and right side panels 320L and 320R, and the bottom panel 330, are more clearly seen.

FIG. 4B is a further enlarged perspective view of the flap unit 350 of FIG. 4A. Here, an illustrative corrugated profile of the left panel 320L is more clearly seen. Creases 322 along the left panel 320L are also more clearly seen. The creases 322 serve as pre-formed cutting guides for the pet owner.

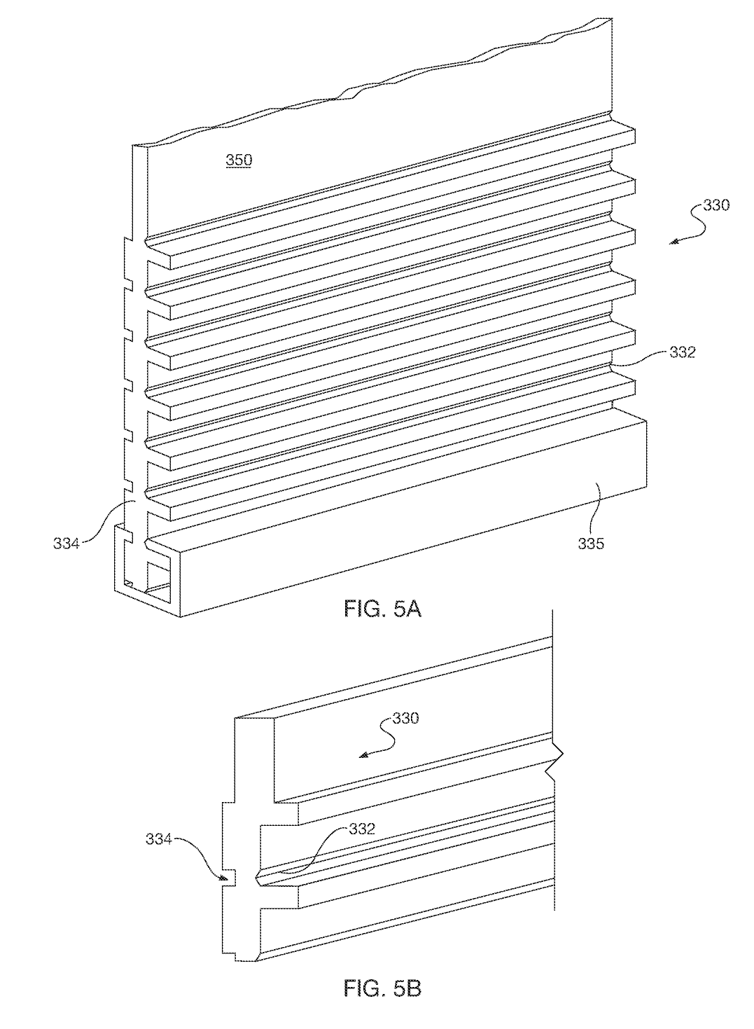

FIG. 5A is an enlarged perspective view of the flap unit 350 of FIG. 1. The bottom panel 330 is more clearly seen. Creases 332 along the bottom panel 330 are also more clearly seen. Here, it can be seen that the bottom panel 330 may include troughs 334 oppositely disposed and aligned with the crease 332 to enable easier cutting of the bottom panel 330 where the creases 332 again serve as pre-formed cutting guides for the pet owner.

FIG. 5B is a further enlarged perspective view of the flap unit 350 of FIG. 5A, but showing only the corrugated, or ridged profile.

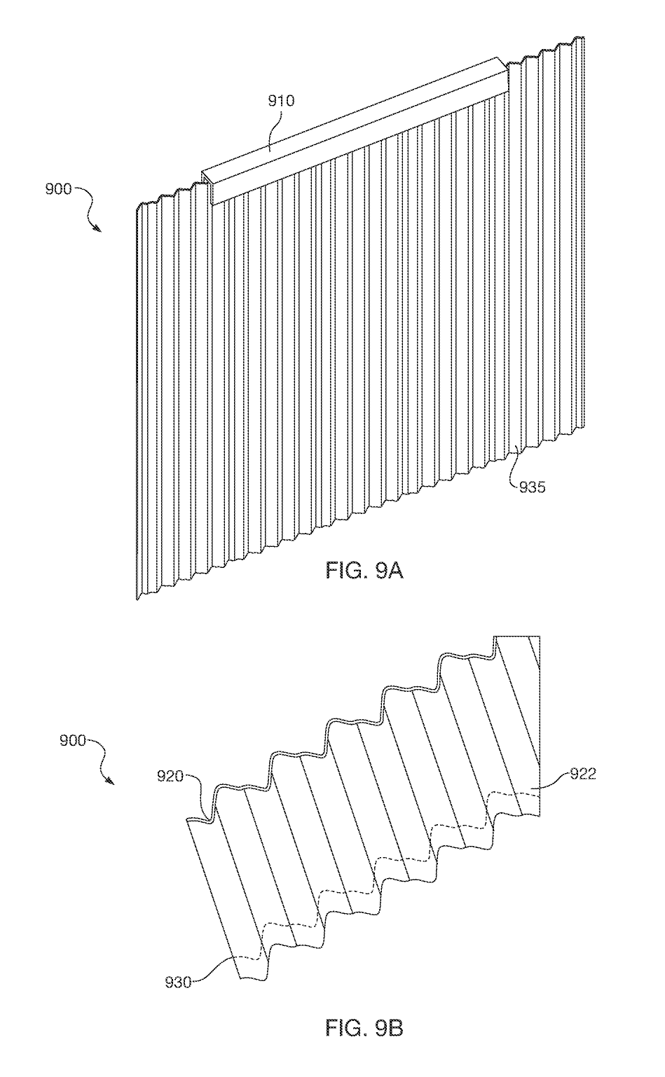

FIG. 6 is a perspective view of an animal door 600 of the present invention, in a second embodiment. The animal door 600 of FIG. 6 is similar to the animal door 100 of FIG. 1. In this respect, the animal door 600 also includes a first frame unit 700B and a second frame unit 700A. The door 600 may also include the flap unit 350 of FIG. 5A (not shown). Alternatively or in addition, the animal door includes a panel unit, seen in FIG. 9A at 900. The frame units 700A, 700B are shown in exploded-apart relation.

Each frame unit 700A, 700B offers two upper floating corner pieces 610A, 610B and two lower floating corner pieces 615A, 615B. In addition, each frame unit 700A, 700B offers opposing horizontal (or upper and lower) bars 620A, 620B. Each frame unit 700A, 700B also offers opposing vertical (or side) bars 625A, 625B. As with door 100 of FIG. 1, the animal door 600 utilizes a slidable arrangement between the floating corner pieces 610, 615 and the corresponding horizontal 620 and vertical 625 bars. In this way, the dimensions of a central through-opening 650 may be adjusted to accommodate changing animal size.

The left and right (625) and the top and bottom (620) bars, respectively, connect to corresponding generally right angle ends of the corner pieces 610B, 615B through slidable or telescopic connections, shown in the drawings as mortise-and-tenon type connections. This forms right and left length adjustable bar members, and top and bottom length adjustable bar members. In the illustrative arrangement of FIG. 6, mortise openings 614A, 614B reside within opposing ends of the top and bottom bars 620A, 620B, while mortise openings 624A, 624B reside within opposing ends of the left and right side bars 625B. Horizontal mortise openings 614A, 614B slidably receive horizontal tenons 623A, 623B, respectively, extending from corresponding corner pieces 610, 615. Similarly, vertical mortise openings 624A, 624B slidably receive vertical tenons 627A, 627B, respectively, extending from corresponding corner pieces 610, 615.

The horizontal tenons of the corner pieces 610, 615 are shown at 623A, 623B, while the vertical tenons of the corner pieces 610, 615 are shown at 627A, 627B.

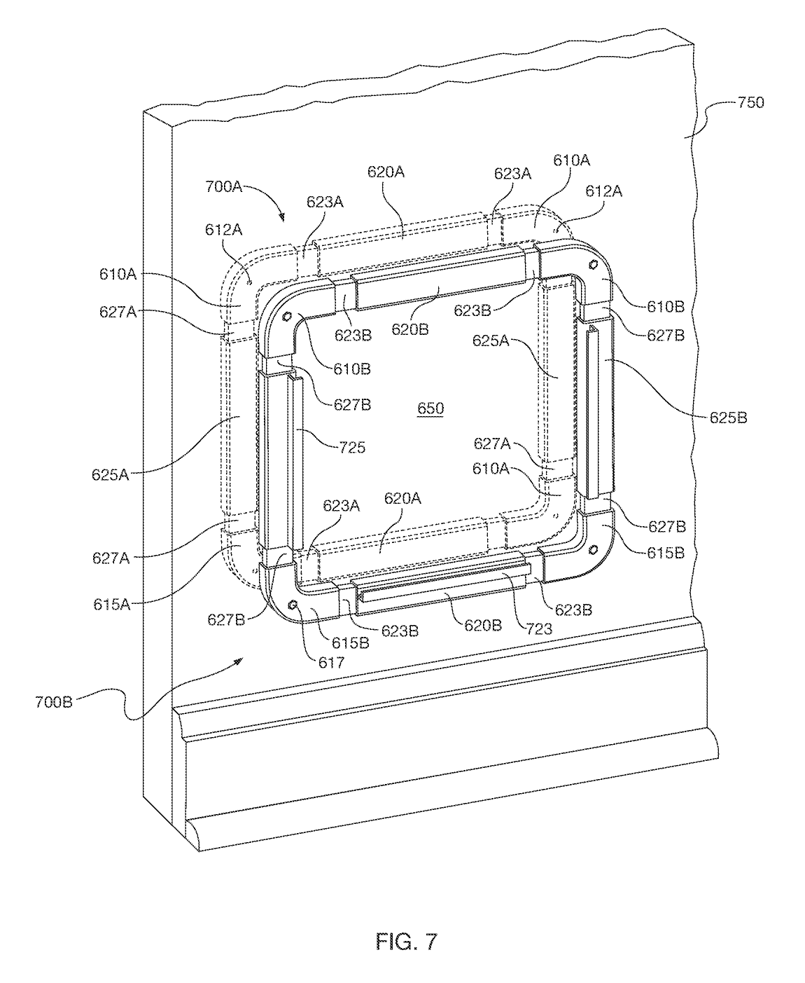

As noted, the animal door 600 of FIG. 6 also includes a panel unit 900. In this arrangement, the panel unit 900 is designed to be slidably received in u-shaped channels 723, 725. The channels 723, 725 reside along an outer face of one of the frame units 700A or 700B, and are seen best in the enlarged view of FIG. 9, discussed below. The panel unit 900 may function as a replacement to the flap unit 350 described above in connection with FIGS. 1 and 2; however, it is preferred that the panel unit 900 operate in addition to the flap unit 350. Thus, while FIGS. 6 and 7 show the animal door 600 without a pivoting flap unit 350, it is understood that it may include the flap unit 350 and corresponding supportive hardware.

The first 700B and second 700A frame units are designed to be coupled to each other so as to be fixedly attached to a structure, such as a residential wall. FIG. 7 is another perspective view of the animal door 600 of FIG. 6. Here, the two frame units 700A, 700B are affixed to opposing surfaces of a wall 750. The frame units 700A, 700B form an opening 650 that generally aligns with a through-opening formed in the wall 750.

In order to secure the first 700B and second 700A frame units to the residential wall 750, one or more mechanical connectors 617 is provided, which are shown in the drawings in the form of bolts 617. In the arrangement of FIGS. 6 and 7, bolts 617 are placed through mounting holes 612B in the corner pieces 610B, 615B. The bolts 617 extend through holes in the door 750 and through corresponding mounting holes 612A in the corner pieces 610A, 615A. Nuts 616 are then threaded onto the bolts 617 and tightened to provide a fixed connection to the wall 750 there between.

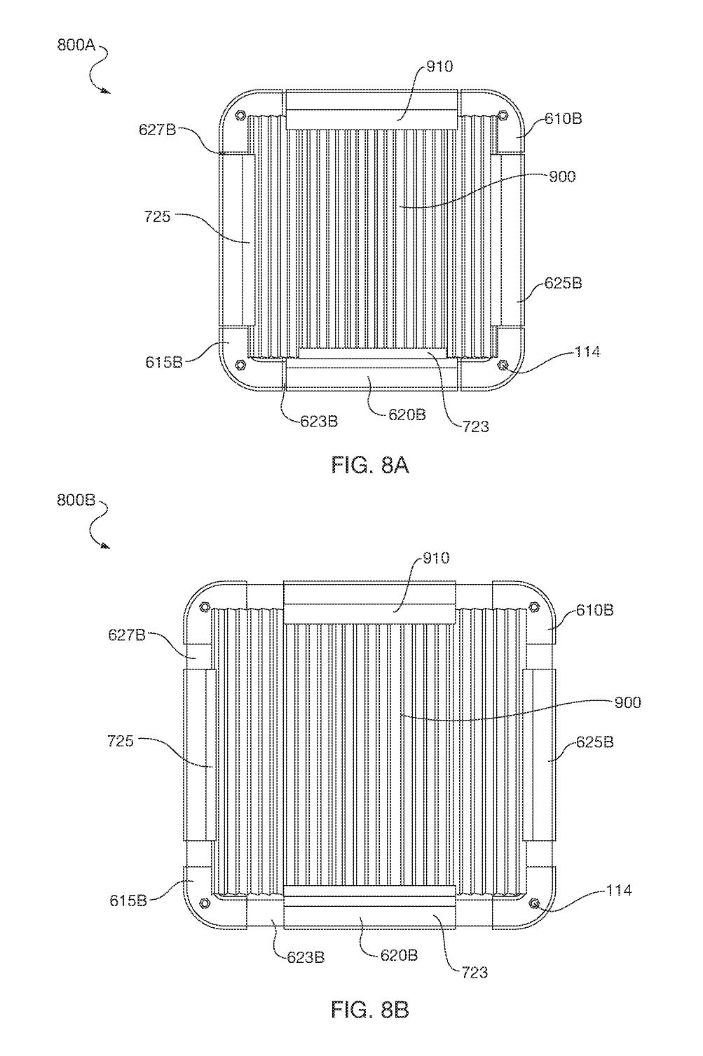

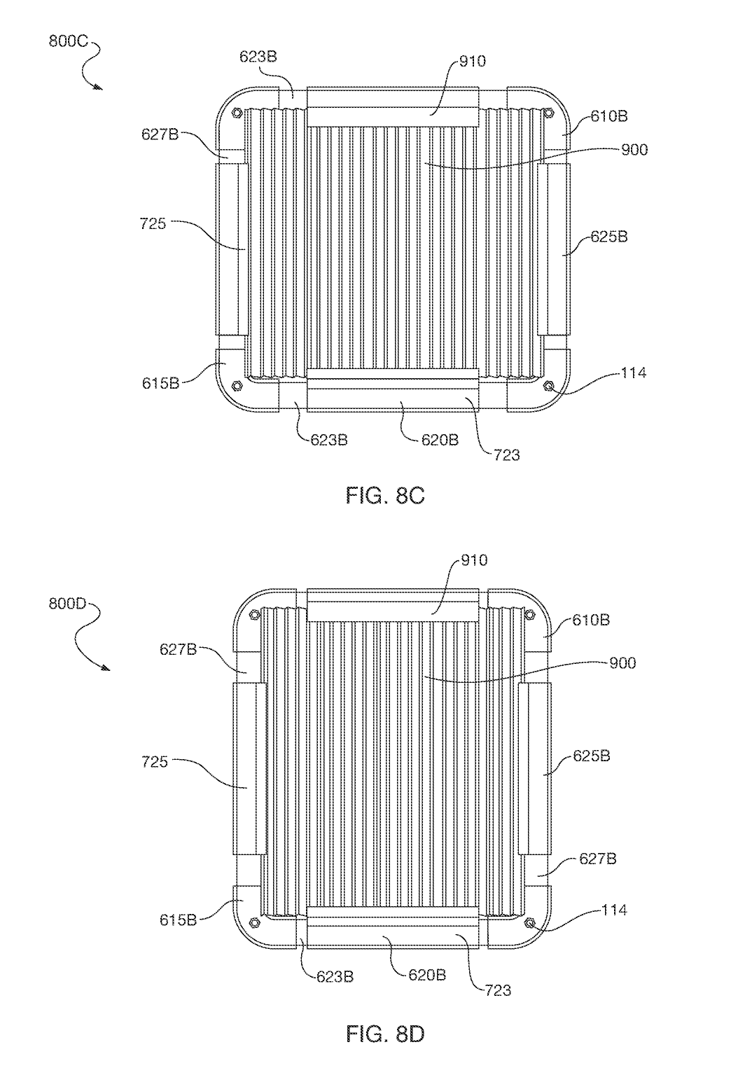

FIG. 8A is a front view of a frame unit 800A having a first dimension. The frame unit 800A has received a slidable panel 900 within u-shaped channels 723, 725. The frame unit 800A serves as part of an animal door 600. In this arrangement, the frame unit 800A has a small first dimension or configuration. The animal door 600 has the right and left side bars 625B moved towards corner pieces 610B and 615B. Similarly, the top and bottom bars 620B are moved towards corner pieces 610B and 615B to provide a small width. However, all tenons 623B, 627B are slightly visible.

FIG. 8B is a front view of a frame unit 800B having a second dimension. The frame unit 800B again serves as part of an animal door 600. Here, slidable components of the frame unit 800B have been adjusted to accommodate both a taller and a wider through-opening in the wall 750 as compared to FIG. 8A. The animal door 600 has the right and left side bars 625B pushed distally from corner pieces 610B, 615B to provide a maximum height, i.e., the tenons 627B of the corner pieces 610B, 615B are positioned farthest from mortise openings 624B of the side bars 625B. Similarly, the top and bottom bars 620B are pushed distally from corner pieces 610B, 615B to provide a maximum width, i.e., the tenons 623B of the corner pieces 610B, 615B are pushed farthest from mortise openings 614B of the bars 620B.

FIG. 8C is another front view of a frame unit 800C having a third dimension. Here, the slidable components of the frame unit 800C have been adjusted to accommodate a wider through-opening in the wall 750. This configuration allows a wider opening for the passage of shorter, squattier pets.

FIG. 8D is another front view of a frame unit 800D having a fourth dimension. Here, the slidable components of the frame unit 800D have been adjusted to accommodate a taller through-opening in the wall 750. The frame unit 800B again serves as part of an animal door 600. pushed distally from corner pieces 610B, 615B to provide a maximum height, i.e., the tenons 627B of the corner pieces 610B, 615B are positioned farthest from mortise openings 624B of the side bars 625B. At the same time, the upper and lower bars 620B are pushed moved towards corner pieces 110B and 115B to provide a minimal width, i.e., the mortise openings 614B of the bars 620B more fully receive the tenons 623B of the corner pieces 610B and 615B.

In any of these arrangements 800B, 800C and 800D, the panel unit 900 will need to be cut-to-size by the owner. This may be done by cutting along pre-fabricated corrugations or creases, or by following cutting lines.

FIG. 9A is a perspective view of the slidable panel unit 900 of the FIG. 8 series. Here, an optional upper handle 910 is shown residing horizontally over the panel unit 900. Vertical corrugations 935 are shown along the panel 900 to aid either in cutting or in collapsing.

FIG. 9B is an enlarged view of the slidable panel unit 900 of FIG. 9A. An upper horizontal edge 920 of the panel unit 900 is shown. Vertical corrugations 935 and a pre-marked, horizontal cutting line 930 are seen.

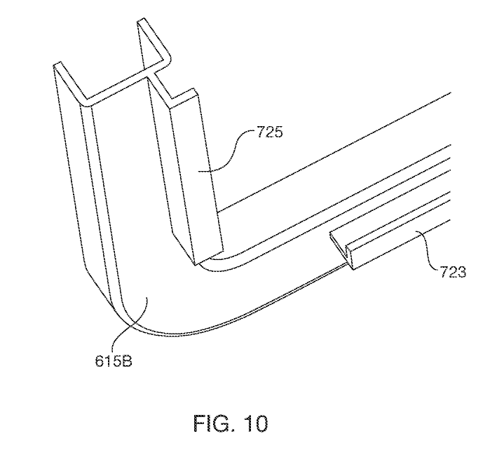

FIG. 10 is an enlarged perspective view of a portion of an illustrative corner piece 615B of the frame unit 700B. A horizontal channel 723 and a vertical channel 725 are seen, configured to receive the slidable panel 900 of FIG. 9A. Of interest, the illustrative channels 723, 725 are attached to the corner piece 615B rather than to bars as shown in FIG. 6.

Based on the above description of the pet doors 100, 600 and their components, a method for installing a pet door is also provided herein. In one aspect, the method includes cutting a through-opening through a door. The through-opening is preferably sized to accommodate a pet dog of a particular size. Thus, the method may also include the step of determining a first size of a pet, wherein the through-opening accommodates the first size of the pet.

The method next includes providing a size-adjustable pet door. The pet door may be in accordance with the pet door as described above in its various embodiments. The pet door will have a first frame unit and a second frame unit, with each frame unit forming a four-sided polygon. Each frame unit comprises slidably mating components that permit each frame unit to have (i) an adjustable height, (ii) an adjustable length, or (iii) both. The pet door will also have a first flap unit fabricated from a polymeric material.

The method further includes sliding the slidable components of each frame unit to form a first opening. The first opening generally aligns with the through-opening of the door.

The method also includes cutting the first flap unit along the cutting guides to generally match the first opening, and then pivotally connecting the first flap unit to the first frame unit. Preferably, the pivoting connection is across an upper side bar of the first frame unit.

The method additionally includes placing the first frame unit along a first surface of the door, and placing the second frame unit along an oppositely disposed second surface of the door. Using a mechanical fastener, the first frame unit is secured to the second frame unit in fixed relation to the door. In this way, a passageway for an animal is formed.

In one embodiment, the method further comprises:
determining a second size of the pet after a period of time;
removing the first flap unit from the first frame unit;
removing the first and second frame units from the door;
cutting the door to expand the through-opening in the door and to accommodate the second size of the pet;
sliding the slidable components of each frame unit to form a second opening within the frame units that aligns with the expanded through-opening of the door;
providing a second flap unit to replace the first flap unit, the second flap unit also having cutting guides;
cutting the second flap unit along the cutting guides to generally match the opening in the frame units;
pivotally connecting the second flap unit to the first frame unit;
placing the first frame unit back along the first surface of the door, and placing the second frame unit back along the second opposing surface of the door; and
using a mechanical fastener, re-securing the first frame unit to the second frame unit in fixed relation to the door, thereby re-forming the passageway for an animal.

In this way, the same frame units may be used as a pet grows. Of course, these additional steps can be repeated to expand the through-opening to accommodate a third determined size of the pet. The only change in hardware that is needed is a new flap unit and, alternatively or in addition, a new panel unit.

Variations of the pet door and the method of installing such may fall within the spirit of the claims, below. It will be appreciated that the inventions are susceptible to modification, variation and change without departing from the spirit thereof.

We claim:

1. A size-adjustable pet door, comprising:
a first frame unit and a second frame unit, wherein:
each frame unit forms a four-sided polygon,
each frame unit is configured to be secured to one side of opposing sides of a barrier,
each frame unit comprises slidably mating components that permit each frame unit to have (i) an adjustable height, (ii) an adjustable width, or (iii) both; and
the slidably mating components of each frame unit form a through-opening configured to generally align with an opening in the barrier;
at least one mechanical fastener for securing the first and second frame units to the barrier in fixed relation;
a flap unit having a series of size-cutting guides; and
a connection member connecting the flap unit to the first frame unit.

2. The pet door of claim 1, wherein the slidably mating components of each frame unit comprise:
four corner pieces;
two opposing vertical bars slidably coupleable to the four corner pieces, forming left and right side bars; and
two opposing horizontal bars also slidably coupleable to the four corner pieces, forming top and bottom bars.

3. The pet door of claim 1, wherein the slidably mating components are telescopically coupled to each other.

4. The pet door of claim 2, wherein:
each of the corner pieces comprises vertical mounting recesses therein; and
each of the two opposing vertical side bars comprises opposing tenons configured to be received within the vertical mounting recesses of the corner pieces to adjust the height of the pet door.

5. The pet door of claim 2, wherein:
each of the corner pieces comprises horizontal mounting recesses therein; and
each of the two opposing horizontal side bars comprises opposing tenons configured to be received within the horizontal mounting recesses of the corner pieces to adjust the width of the pet door.

6. The pet door of claim 5, wherein:
each of the corner pieces further comprises vertical mounting recesses therein; and
each of the two opposing vertical side bars comprises tenons configured to be received within the vertical mounting recesses of the corner pieces to also adjust the height of the pet door.

7. The pet door of claim 5, wherein the barrier is a door or a wall.

8. The pet door of claim 7, wherein the connection member is a pivoting connection member that pivotally connects the flap unit to an upper bar of the first frame unit.

9. The pet door of claim 8, wherein the flap unit comprises a series of vertically-oriented size cutting guides and a series of horizontally-oriented size cutting guides.

10. The pet door of claim 9, wherein:
the vertically-oriented cutting guides are placed along opposing left and right side panels; and
the horizontally-oriented cutting guides reside along a bottom panel.

11. The pet door of claim 9, wherein:
the flap unit further comprises a central panel;
the series of vertically-oriented size cutting guides includes a first series of vertically oriented size cutting guides, a central panel, and a second series of vertically-oriented size cutting guides oppositely disposed across the central panel from the first series of vertically-oriented size cutting guides; and
each of the cutting guides comprises a corrugated profile such that the cutting guides are formed at least partially by corrugations in the panels.

12. The pet door of claim 9, wherein:
the first frame unit comprises a ferro-magnetic element along bottom bar, and
the flap unit has a magnetic connector coupled to a bottom portion of the flap unit to magnetically cooperate with the ferro-magnetic element, thereby biasing the flap unit to reside in a closed position adjacent the bottom bar of the first frame unit.

13. The pet door of claim 7, wherein:
the flap unit comprises a panel; and
the connection member comprises at least two u-shaped channels disposed along an outer surface of one of the frame members, the u-shaped channels being configured to gravitationally receive the panel.

14. The pet door of claim 13, wherein the panel comprises a series of vertically-oriented size cutting guides.

15. The pet door of claim 8, wherein:
the connection member is a pivoting connection member that pivotally connects the flap unit to an upper bar of the first frame unit; and
the pet door further comprises:
a panel; and
at least two u-shaped channels disposed along an outer surface of one of the frame members, the u-shaped channels being configured to gravitationally receive the panel and to substantially cover one side of the flap unit.

16. A method for installing a pet door, comprising:
cutting a through-opening through a barrier;
providing a size-adjustable pet door, comprising:
a first frame unit and a second frame unit, wherein each frame unit comprises slidably mating components that permit each frame unit to have (i) an adjustable height, (ii) an adjustable width, or (iii) both; and
a first flap unit having cutting guides;
connecting the slidably mating components of each frame unit to form a first opening within each of the frame units that generally aligns with the through-opening within the barrier;
cutting the first flap unit along one or more of the cutting guides to generally cover the first opening;
connecting the first flap unit to the first frame unit;
placing the first frame unit along a first surface of the barrier;
placing the second frame unit along a second opposing surface of the barrier; and
using a mechanical fastener, securing the first frame unit to the second frame unit in fixed relation to the barrier, thereby forming a passageway for an animal.

17. The method of claim 15, further comprising:
removing the first flap unit from the first frame unit;
removing the first and second frame units from the barrier;
cutting the door to expand the through-opening in the barrier;
connecting the slidably mating components of each frame unit to increase the size of the first opening to form a second opening within the frame units that aligns with the expanded through-opening of the barrier;
providing a second flap unit to replace the first flap unit, the second flap unit also having cutting guides;
cutting the second flap unit along one or more of the cutting guides to generally cover the second opening in the frame units;
connecting the second flap unit to the first frame unit;
placing the first frame unit back along the first surface of the barrier, and placing the second frame unit back along the second opposing surface of the barrier; and
using a mechanical fastener, re-securing the first frame unit to the second frame unit in fixed relation to the barrier, thereby re-forming the passageway for an animal.

18. The method of claim 17, wherein the barrier is a door or a wall.

19. The method of claim 18, wherein the first flap unit comprises (i) a central panel, (ii) left and right side panels, and (iii) a bottom panel, or (iv) both left and right side panels and a bottom panel.

20. The method of claim 18, wherein the animal door further comprises:
a pivoting connection member arranged to pivotally connect the flap unit to a horizontal, upper frame member along the first frame unit.

21. The method of claim 20, wherein:
the first frame unit comprises a ferro-magnetic element along a bottom bar of the first frame unit, and
the flap unit has a magnetic connector coupled to a bottom portion of the flap unit to magnetically cooperate with the ferro-magnetic element, thereby biasing the flap unit to reside in a closed position adjacent the bottom bar of the first frame unit.

22. The method of claim 18, wherein the cutting guides comprise a series of creases that form vertical cutting guides.

23. The method of claim 20, wherein:
the pet door further comprises a first panel, and at least two u-shaped channels disposed along an outer surface of one of the frame members, the u-shaped channels being configured to gravitationally receive the first panel; and
the method further comprises:
gravitationally placing the first panel into the u-shaped channels to substantially cover one side of the first flap unit and to block the passageway.

24. The method of claim 18, wherein
the first flap is a first panel;
the second flap is a second larger panel; and
the steps of connecting the first flap unit to the first frame unit and connecting the second flap unit to the first frame unit comprise gravitationally releasing the respective flap units down into the channels to block the passageway.

25. The method of claim 18, wherein the slidably mating components of each frame unit comprise:
four corner pieces,
two opposing vertical side bars slidably coupleable to the four corner pieces, forming left and right side bars; and
two opposing horizontal side bars slidably coupleable to the four corner pieces, forming top and bottom bars.

26. A size-adjustable pet door adapted to be mounted to a structural barrier having a through-opening, comprising:
a first frame unit having a first pair of length-adjustable vertical bar members and a first pair of length-adjustable horizontal bar members which define a first frame unit opening;
a second frame unit having a second pair of length-adjustable vertical bar members and a second pair of length-adjustable horizontal bar members which define a second frame unit opening;
a fastener coupling the first frame unit and the second frame unit to the structural barrier, and
a flap unit coupled to one of the first and second frame units, the flap unit having a series of vertical cutting guides and one or more horizontal cutting guides,
whereby the first and second frame units may each be varied in size by adjusting the length of the length-adjustable vertical bar members and the length-adjustable horizontal bar members to conform with the size of the barrier through-opening, and the size of the flap may be adjusted for the size of the opening formed by the first and second frame units by removing portions of the flap through cutting along the series of vertical cutting guides and/or the one or more horizontal cutting guides.

27. The pet door of claim 26, wherein the structural barrier is a door or a wall.

28. The pet door of claim 27, wherein the flap unit is pivotally connected to the first frame unit along an upper horizontal bar member.

29. The pet door of claim 28, further comprising:
a panel unit configured to be releasably connected to the first frame unit by gravitationally releasing the panel unit into two or more channels disposed along an outer surface of the first frame unit.

30. The pet door of claim 27, wherein the flap unit is a panel unit configured to be releasably connected to the first frame unit by gravitationally releasing the panel unit into two or more channels disposed along an outer surface of the first frame unit.

31. The size-adjustable pet door of claim 27, wherein:
the first pair of length-adjustable vertical bar members includes a first pair of vertical side bars and four floating corner pieces configured to be slidably coupled to the first pair of vertical side bars;
the first pair of length-adjustable horizontal bar members includes a first pair of horizontal side bars also configured to be slidably coupled to the four first corner pieces;
the second pair of length-adjustable vertical bar members includes a second pair of vertical side bars and four second corner pieces configured to be slidably coupled to the second pair of vertical side bars;
the second pair of length-adjustable horizontal bar members includes a second pair of horizontal side bars configured to be slidably coupled to the four second corner pieces.

32. The size-adjustable pet door of claim 31, wherein:
each side bar of the first pair of vertical side bars has a central portion and two oppositely disposed tenons;
each side bar of the first pair of horizontal side bars has a central portion and two oppositely disposed tenons;
each side bar of the second pair of vertical side bars has a central portion and two oppositely disposed tenons;
each side bar of the second pair of horizontal side bars has a central portion and two oppositely disposed tenons; and
each of the first and second corner pieces has recesses configured to receives the tenons of either the first or second pair of vertical side bars or the first or second pair of horizontal side bars.

33. The size adjustable pet door of claim 31 wherein the flap unit comprises:
a central panel, and left and right side panels extending from opposite sides of the central panel;
vertical cutting guides placed along each of the left and right side panels;
a bottom panel extending from a bottom of the central panel; and
horizontal cutting guides placed along the bottom panel.
